(19) United States
(12) Patent Application Publication
(10) Pub. No.: US 2013/0262032 A1
(43) Pub. Date: Oct. 3, 2013

(54) INFORMATION PROCESSING DEVICE, INFORMATION PROCESSING METHOD, AND PROGRAM

(71) Applicant: SONY CORPORATION, Tokyo (JP)

(72) Inventor: Naoki Ide, Tokyo (JP)

(73) Assignee: Sony Corporation, Tokyo (JP)

(21) Appl. No.: 13/777,499

(22) Filed: Feb. 26, 2013

(30) Foreign Application Priority Data
Mar. 28, 2012 (JP) 2012-073506

(51) Int. Cl. G06F 17/18

(52) U.S. Cl. CPC G06F 17/18
USPC 702/181

(57) ABSTRACT

An information processing device includes a main sensor that is a sensor that is operated in at least two operation levels and acquires predetermined data, a sub sensor that is a sensor that acquires data different from that of the main sensor, and an information amount calculation unit that predicts the difference between an information amount when measurement is performed by the main sensor and an information amount when measurement is not performed by the main sensor from data obtained by the sub sensor and decides the operation level of the main sensor based on the prediction result.

### BACKGROUND

The present technology relates to an information processing device, an information processing method, and a program, and particularly to an information processing device, an information processing method, and a program that can drive and control a sensor so as to extract information to the maximum extent while reducing measurement costs.

Various kinds of sensors are mounted on a mobile device such as a smartphone so as to facilitate use thereof. Applications which provide users of services tailored for them using data obtained by such mounted sensors have been developed.

However, measurement costs are generally incurred when a sensor is operated. As a measurement cost, for example, consumption power of a battery consumed during measurement by a sensor can be typically exemplified. For this reason, if a sensor is operated all the time, measurement costs are accumulated, and accordingly, there are cases in which measurement costs are too enormous to compare with costs of a single measurement.

In the related art, there is a method of controlling a plurality of sensors which is configured to preferentially transmit sensor information having a great contribution in a sensor node on a sensor network for collecting information detected by the plurality of sensors (for example, refer to Japanese Unexamined Patent Application Publication No. 2007-80190).

### SUMMARY

However, there are many cases in which sensor information having a great contribution such as information in which data is highly accurate or information of which measurement is frequently performed generally incurs high measurement costs. In addition, there is a possibility that it is difficult to obtain desired correct information when data that is likely to be acquired from a plurality of sensors is merely predicted and the prediction is inaccurate. Thus, it is considered that the method of the related art disclosed in Japanese Unexamined Patent Application Publication No. 2007-80190 does not contribute to a reduction in measurement costs or lowers accuracy.

It is desirable for the present technology to drive and control a sensor so as to extract information to the maximum extent while reducing measurement costs.

According to an embodiment of the present technology, there is provided an information processing device which includes a main sensor that is a sensor that is operated in at least two operation levels and acquires predetermined data, a sub sensor that is a sensor that acquires data different from that of the main sensor, and an information amount calculation unit that predicts the difference between an information amount when measurement is performed by the main sensor and an information amount when measurement is not performed by the main sensor from data obtained by the sub sensor and decides the operation level of the main sensor based on the prediction result.

According to another embodiment of the present technology, there is provided an information processing method of an information processing device that includes a main sensor that is a sensor that is operated in at least two operation levels and acquires predetermined data, and a sub sensor that is a sensor that acquires data different from that of the main sensor, and the method includes steps of predicting the difference between an information amount when measurement is performed by the main sensor and an information amount when measurement is not performed by the main sensor from data obtained by the sub sensor and deciding the operation level of the main sensor based on the prediction result.

According to still another embodiment of the present technology, there is provided a program for causing a computer that processes data acquired by a main sensor and a sub sensor to execute processes of predicting the difference between an information amount when measurement is performed by the main sensor and an information amount when measurement is not performed by the main sensor from data obtained by the sub sensor and deciding an operation level of the main sensor based on the prediction result.

According to the embodiments of the present technology, the difference between an information amount when measurement is performed by the main sensor and an information amount when measurement is not performed by the main sensor is predicted so as to decide whether or not the measurement by the main sensor is performed based on the prediction result.

Note that the program can be provided by being transmitted through a transmission medium, or recorded on a recording medium.

The information processing device may be an independent device, or an internal block constituting one device.

According to the embodiments of the present technology, it is possible to drive and control a sensor so as to extract information to the maximum extent while reducing measurement costs.

### BRIEF DESCRIPTION OF THE DRAWINGS

FIG. 1 is a block diagram showing a configuration example of an embodiment of a measurement control system to which the present technology is applied;

FIG. 2 is a diagram showing an example of time series data;

FIG. 3 is a diagram showing another example of time series data;

FIG. 4 is a diagram showing a state transition diagram of a Hidden Markov Model;

FIG. 5 is a diagram showing an example of a transition table of the Hidden Markov Model;

FIG. 6 is a diagram showing an example of a state table in which observation probabilities of the Hidden Markov Model are stored;

FIGS. 7A and 7B are diagrams showing examples of state tables in which observation probabilities of the Hidden Markov Model are stored;

FIG. 8 is a diagram describing an example in which a state table of sub data is created;

FIG. 9 is a block diagram only showing portions relating to control of a main sensor from FIG. 1;

FIG. 10 is a diagram describing a process of a measurement entropy calculation unit;

FIG. 11 is a trellis diagram describing prediction calculation by a state probability prediction unit;

FIG. 12 is a diagram describing a process of the measurement entropy calculation unit;

FIG. 13 is a diagram describing an approximate calculation method of the difference of information entropies;

FIG. 14 is a diagram showing an example of a variable conversion table;

FIG. 15 is a flowchart describing a sensing control process;

FIG. 16 is a flowchart describing a data restoration process; and

FIG. 17 is a block diagram showing a configuration example of an embodiment of a computer to which the present technology is applied.

### DETAILED DESCRIPTION OF EMBODIMENTS

### Configuration Example of Measurement Control System

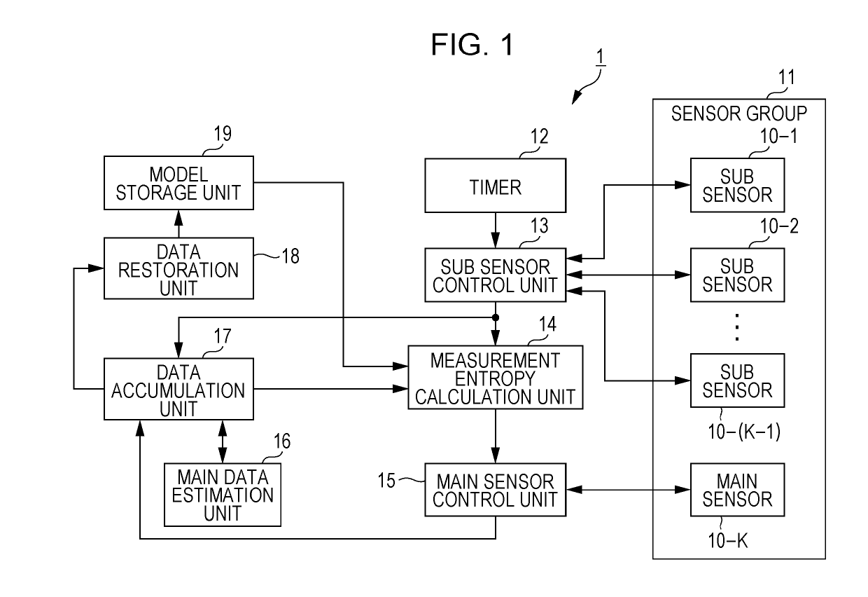

FIG. 1 shows a configuration example of an embodiment of a measurement control system to which the present technology is applied.

The measurement control system 1 shown in FIG. 1 is configured to include a sensor group 11 including K sensors 10, a timer 12, a sub sensor control unit 13, a measurement entropy calculation unit 14, a main sensor control unit 15, a main data estimation unit 16, a data accumulation unit 17, a data restoration unit 18, and a model storage unit 19.

The K sensors 10 included in the sensor group 11 can be divided into K−1 sub sensors 10-1 to 10-(K−1), and one main sensor 10-K. The measurement control system 1 controls whether or not measurement by the main sensor 10-K is performed using measured data of the K−1 sub sensors 10-1 to 10-(K−1). Note that, hereinbelow, when it is not particularly necessary to discriminate each of the sub sensors 10-1 to 10-(K−1), they will be referred to as the sub sensor 10, and the main sensor 10-K will also be referred to simply as the main sensor 10.

Each of the sub sensors 10-1 to 10-(K−1) (K≧2) has two operation levels of turning on and off, and is operated at a predetermined operation level according to control of the sub sensor control unit 13. Each of the sub sensors 10-1 to 10-(K−1) (K≧2) is a sensor which measures data that has a correlation with data measured by the main sensor 10, and outputs data that can be supplementarily used instead of causing the main sensor 10 to measure.

When the main sensor 10 is a Global Positioning System (GPS) sensor mounted on mobile devices such as smartphones, for example, the sub sensor 10 can be configured as a sensor, for example, an acceleration sensor, a geomagnetic sensor, a pneumatic sensor, or the like.

Note that, since the sub sensor 10 may be one that can obtain data that has a correlation with data measured by the main sensor 10, it may not be called as a sensor in general. If the main sensor 10 is a GPS sensor that acquires position data, for example, a device that obtains the ID, area code, scrambling code of a cell (communication base station), a signal intensity of reception intensity (RSSI), signal intensity of a pilot signal (RSCP), or the like, a radio wave intensity of a wireless LAN, or the like which help computation of positions can also be set as the sub sensor 10. Information of a cell (communication base station) is not limited to a serving cell which indicates a base station performing communication, and can also be used of a neighbor cell that is a base station which does not perform communication but can be detected.

The main sensor 10 is a sensor for obtaining data that serves as the original measurement target. The main sensor 10 is, for example, a GPS sensor as described above that is mounted on mobile devices such as smartphones so as to acquire current positions (including latitude and longitude).

The main sensor 10 has two operation levels of turning on and off, and is operated at a predetermined operation level according to the control of the main sensor control unit 15. The main sensor 10 is a sensor that is advantageous to the measurement control system 1 if it can pause measurement by using measured data of the sub sensor 10 instead. In other words, if consumption power of a battery and a processing load of a CPU caused when measurement by each sensor 10 is performed are considered to be measurement costs, measurement costs of the main sensor 10 are higher than those of any one of the sub sensors 10. Note that, in the present embodiment, there are two operation levels of the main sensor 10 which are turning on and off, but the operation level of turning on can be further finely divided into high, medium, and low. In other words, the main sensor 10 may have at least two operation levels.

The timer 12 is a clock (counter) used by the sub sensor control unit 13 to gauge measurement times, and supplies count values indicating times elapsed to the sub sensor control unit 13.

The sub sensor control unit 13 acquires data measured by the K−1 sub sensors 10 at a predetermined time interval based on count values of the timer 12, and supplies the data to the measurement entropy calculation unit 14 and the data accumulation unit 17. Note that it is not necessary for the K−1 sub sensors 10 to acquire data at the same time interval.

The measurement entropy calculation unit 14 calculates the difference (difference of information entropies) of an information amount (information entropy) when measurement by the main sensor 10 is performed and an information amount (information entropy) when measurement by the main sensor 10 is not performed using a learning model supplied from the model storage unit 19 and data obtained by the sub sensors 10. Then, the measurement entropy calculation unit 14 decides whether or not the main sensor 10 is operated in order to perform measurement based on the calculated difference of the information amounts, and then supplies the decided result to the main sensor control unit 15.

That is to say, when the difference of the information amount when measurement is performed and the information amount when measurement is not performed by the main sensor 10 is great, in other words, when the information amount obtained by causing the main sensor 10 to operate is great, the measurement entropy calculation unit 14 decides to cause the main sensor 10 to operate. On the other hand, when the obtained information amount is small even though the main sensor 10 is operated, the main sensor 10 is decided not to be operated. Note that, as a learning model in which time series data obtained in the past and stored in the model storage unit 19 is learned, a Hidden Markov Model is employed in the present embodiment. The Hidden Markov Model will be described later.

When the main sensor 10 is decided to be operated by the measurement entropy calculation unit 14, the main sensor control unit 15 causes the main sensor 10 to operate so as to acquire data by the main sensor 10 and supplies the data to the data accumulation unit 17.

The main data estimation unit 16 estimates time series data that has been accumulated prior to a time t when measurement by the main sensor 10 is not performed at the time t and data not measured by the main sensor 10 based on measured data by the sub sensors 10 at the time t. For example, the main data estimation unit 16 estimates a current value from the positions and signal intensities of a plurality of detected cells, instead of position information measured by a GPS sensor at the time t. The time in which the main data estimation unit 16 estimates data to be measured by the main sensor 10 is when the information amount obtained by the measurement entropy calculation unit 14 by causing the main sensor 10 to operate is small. Thus, even if data to be obtained by the main sensor 10 is generated using data obtained by the sub sensors 10, there is no significant difference in an obtained information amount, and therefore, data with the same accuracy as that obtained from measurement by the main sensor 10 can be generated.

The data accumulation unit 17 stores data supplied from the sub sensor control unit 13 (hereinafter, referred to as sub data) and data supplied from the main sensor control unit 15 (hereinafter, referred to as main data). The data accumulation unit 17 accumulates data measured by the sub sensors 10 and the main sensor 10 at a short time interval such as at an interval of one second, or one minute for a given period of time such as one day or in a given amount, and supplies the accumulated time series data to the data restoration unit 18.

Note that there are cases in which it is difficult to acquire data depending on the state of measurement, for example, when the GPS sensor performs measurement inside a tunnel, as in the case in which some of time series data pieces which are measurement results of the sub sensors 10 and the main sensor 10 are missing.

When some of time series data pieces which are accumulated for a given period of time or in a given amount are missing, the data restoration unit 18 applies a Viterbi algorithm to the time series data pieces so as to execute a data restoration process to restore missing data pieces. The Viterbi algorithm is an algorithm used to estimate a most likely state series from given time series data and the Hidden Markov Model.

In addition, using the accumulated time series data, the data restoration unit 18 updates parameters of the learning model stored in the model storage unit 19. Note that, in updating the learning model, time series data of which missing data pieces have been restored may be used, or accumulated time series data may be used without change.

The model storage unit 19 stores the parameters of the learning model in which the correlation of the main sensor 10 and the sub sensors 10 and a temporal transition of each of the main sensor 10 and the sub sensors 10 are learned using time series data obtained by the main sensor 10 and the sub sensors 10 in the past. In the present embodiment, as the learning model, the Hidden Markov Model (HMM) is employed, and parameters of the Hidden Markov Model are stored in the model storage unit 19.

Note that, the learning model for learning the time series data obtained by the main sensor 10 and the sub sensors 10 in the past is not limited to the Hidden Markov Model, and other learning model may be employed. In addition, the model storage unit 19 may store the time series data obtained by the main sensor 10 and the sub sensors 10 in the past as a database without change, or may be directly used.

The parameters of the learning model stored in the model storage unit 19 are updated by the data restoration unit 18 using time series data newly accumulated in the data accumulation unit 17. That is to say, data is added to the learning model stored in the model storage unit 19, or the database is expanded.

In the measurement control system 1 configured as above, the difference of the information amount when measurement is performed by the main sensor 10 and the information amount when measurement is not performed by the main sensor 10 is calculated based on data obtained by the sub sensors 10. Then, when the information amount obtained from measurement by the main sensor 10 is determined to be great, the main sensor 10 is controlled to operate.

Herein, measurement cost that is cost incurred when the sub sensors 10 operate is lower than that incurred when the main sensor 10 operates, and only when the information amount obtained by the main sensor 10 operating is great, the main sensor 10 operates. Accordingly, the main sensor 10 can be driven and controlled so as to extract information to the maximum extent while measurement costs are reduced.

Hereinbelow, details of each unit of the measurement control system 1 will be described.

### Example of Time Series Data

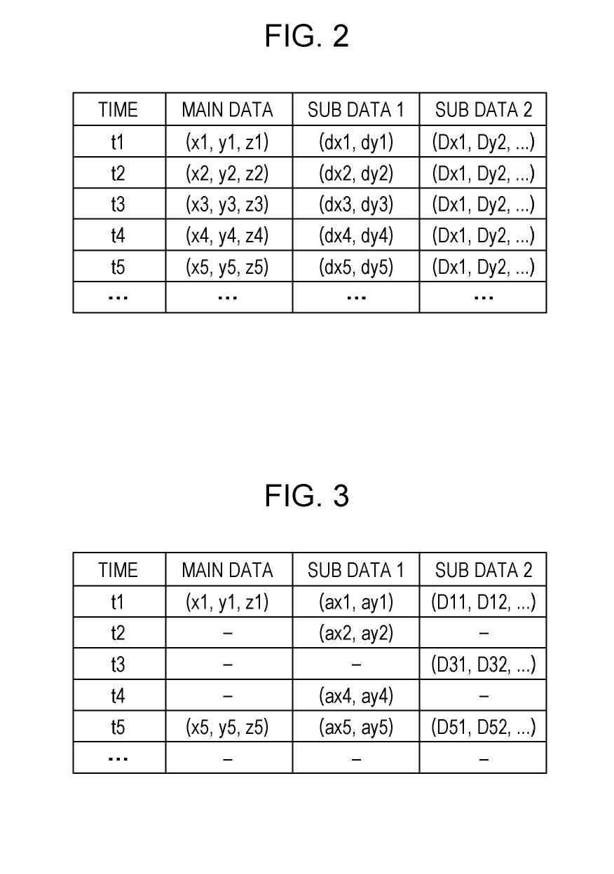

FIG. 2 shows an example of time series data obtained by the main sensor 10 and the sub sensors 10.

To describe using the above-described example, main data obtained by the main sensor 10 is, for example, data of longitude and latitude acquired from a GPS sensor. To describe using the above-described example, sub data obtained by the sub sensors 10 is, for example, data obtained using the ID of a cell, a signal intensity, an acceleration sensor, a geomagnetic sensor, and the like.

Note that the sub sensor control unit 13 can process data output by the sub sensors 10 so as to be easily used instead of main data that was originally intended to be obtained, and output the processed data so as to be stored. For example, the sub sensor control unit 13 can calculate a movement distance vector (odometry) from data obtained directly from an acceleration sensor or a geomagnetic sensor, and output the vector as sub data 1 so as to be stored. In addition, for example, the sub sensor control unit 13 can process a communication region of a serving cell in the form expressed by the center value and a variance value of the position of the serving cell from data of the pair of the cell ID of the serving cell, RSSI (reception intensity), and RSCP (the signal intensity of a pilot signal), and outputs the data as sub data 2 so as to be stored. The example shown in FIG. 2 is set to have two types of sub data, but the number of types of sub data is not limited.

FIG. 3 shows another example of the time series data obtained by the main sensor 10 and the sub sensors 10.

Since the main sensor 10 and the sub sensors 10 are not able to acquire data at all times, there are cases in which main data and sub data include missing data shown in FIG. 3. In the present embodiment, when there is an omission in data, the measurement entropy calculation unit 14 calculates the difference in information entropies using the data including the omission without change. However, when there is an omission in data, the measurement entropy calculation unit 14 may supply the data to the data restoration unit 18 first, complements the missing portion of the data, and uses the complemented time series data so as to calculate the difference in information entropies.

### Hidden Markov Model

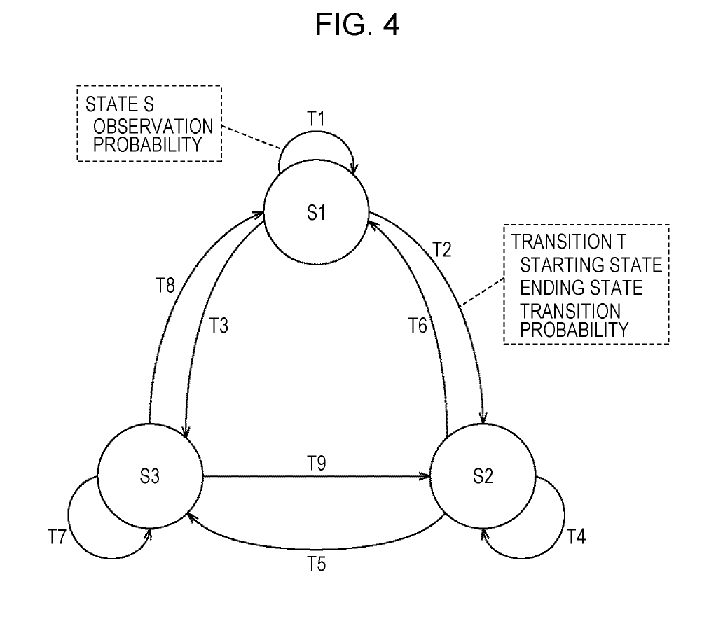

With reference to FIGS. 4 to 8, the Hidden Markov Model in which the time series data obtained by the main sensor 10 and the sub sensors 10 is modeled will be described.

FIG. 4 is a state transition diagram of the Hidden Markov Model.

The Hidden Markov Model is a probability model to model time series data using a transition probability and an observation probability of a state in hidden layers. Details of the Hidden Markov Model are described in, for example, “Algorithm for Pattern Recognition and Learning” written by Yoshinori Uesaka and Kazuhiko Ozeki, Bun-ichi Sogo Shuppan, and “Pattern Recognition and Machine Learning” written by C. M. Bishop, Springer Japan, and the like.

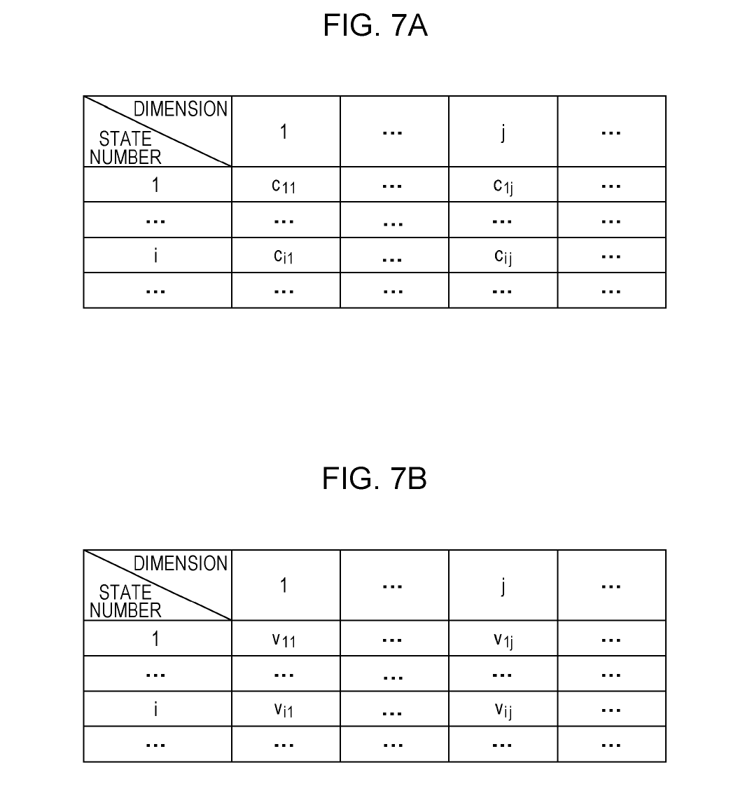

FIG. 4 shows three states of a state S1, a state S2, and a state S3, and nine transitions T of transition T1 to T9. Each of the transitions T is defined by three parameters of a starting state indicating the state before a transition, an ending state indicating the state after a transition, and a transition probability indicating a probability in which a state is transitioned from a starting state to an ending state. In addition, each state has an observation probability indicating a probability that each symbol is taken as a parameter based on which discrete symbol of which data is decided in advance will be taken. Thus, such parameters are stored in the model storage unit 19 in which the Hidden Markov Model is stored as a learning model in which the time series data obtained by the main sensor 10 and the sub sensors 10 in the past is learned. Parameters of a state differ according to a configuration of data, in other words, whether a data space (observation space) is a discrete space or a continuous space as will be described later with reference to FIGS. 6, 7A, and 7B.

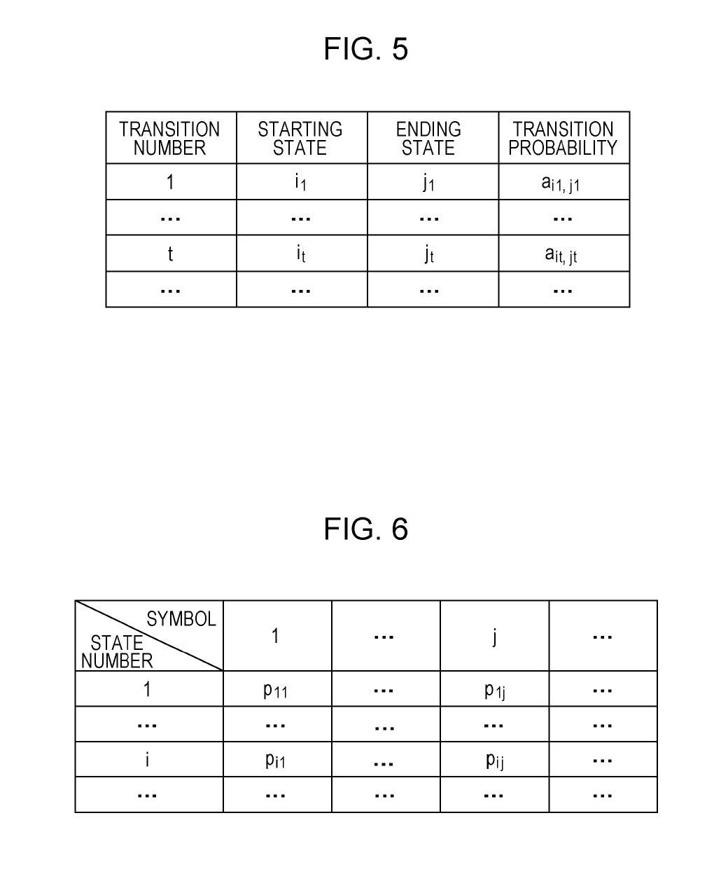

FIG. 5 shows an example of a transition table in which parameters of a starting state, an ending state, and a transition probability of each transition t of the Hidden Markov Model are stored.

The transition table shown in FIG. 5 stores starting states, ending states, transition probabilities per transition t in the state in which transition numbers (serial numbers) for identifying each transition t are given thereto. For example, a t-th transition indicates a transition from a state iₜ to a state jₜ, and the probability thereof (transition probability) is aᵢₜⱼₜ. Note that a transition probability is standardized for transitions having the same starting state.

FIGS. 6, 7A, and 7B show examples of state tables in which observation probabilities which are parameters of a state S are stored.

FIG. 6 shows an example of a state table in which observation probabilities of each state are stored when a data space (observation space) is a discrete space, in other words, when data takes any one of discrete symbols.

In the state table shown in FIG. 6, probabilities that each symbol is taken are stored for state numbers given to each state of the Hidden Markov Model in a predetermined order. There are N states of S1, . . . , Si, . . . , and SN, and symbols that can be taken in the data space are 1, . . . , j, . . . , and K. In this case, for example, the probability that a symbol j is taken in an i-th state Si is pᵢⱼ. However, this probability pᵢⱼ is standardized for the same state Si.

FIGS. 7A and 7B show an example of a state table in which observation probabilities of each state when a data space (observation space) is a continuous space, in other words, when data takes a continuous symbol and further follows a normal distribution that is decided in advance for each state are stored.

When data takes a continuous symbol and follows a normal distribution decided in advance for each state, center values and variance values of the normal distribution that typify the normal distribution of each state are stored as a state table.

FIG. 7A is a state table in which the center values of the normal distribution of each state are stored, and FIG. 7B is a state table in which the variance values of the normal distribution of each state are stored. In the examples of FIGS. 7A and 7B, there are N states of S1, . . . , Si, . . . , and SN, and the number of dimensions of the data space is 1, . . . , j, . . . , and D.

According to the state tables shown in FIGS. 7A and 7B, j-dimensional components of data obtained in, for example, i-th state Si are obtained in a distribution following the normal distribution of a center value cᵢⱼ and a variance value vᵢⱼ.

In the model storage unit 19 in which the parameters of the Hidden Markov Model are stored, one transition table shown in FIG. 5 and a plurality of state tables corresponding to each piece of main data and a plurality of sub data pieces are stored. The state tables corresponding to each piece of the main data and the plurality of sub data pieces is stored in the model storage unit 19 in the form of FIG. 6 when the data space of the main data or the sub data pieces is a discrete space, and in the form of FIGS. 7A and 7B when the data space of the main data or the sub data pieces is a continuous space.

When the main data is GPS data obtained by a GPS sensor, for example, the main data is continuous data that takes the values of real numbers not the values of integers, and thus, a state table of the main data is stored in the model storage unit 19 in the form of the state table for continuous symbols shown in FIGS. 7A and 7B.

In this case, the state table of the main data becomes a table obtained in such a way that a user who holds a mobile device on which a GPS sensor is mounted discretizes positions where he or she frequently goes or passes as states and the center value and variance values of each of the discretized states are stored therein.

Thus, a parameter cᵢⱼ in the state table of the GPS data indicates the center value of a position corresponding to a state Si out of states obtained by discretized positions where the user frequently passes. A parameter vᵢⱼ in the state table of the GPS data indicates a variance value of a position corresponding to the state Si.

Note that, since the GPS data is configured to include two types of data such as latitude and longitude, the dimension number of the GPS data can be considered to be 2 by setting j=1 to be the latitude (x axis) and j=2 to be the longitude (y axis). Note that the dimension number of the GPS data may be 3 by incorporating time information into the GPS data.

Next, an example in which a state table of time series data of a cell ID of a communication base station is created will be described as an example of a state table of sub data.

Since the cell ID of a communication base station is integer data assigned to each base station, it is a discrete symbol. Thus, as a state table of cell IDs of communication base stations as sub data, the form of the state table for discrete symbols shown in FIG. 6 is used.

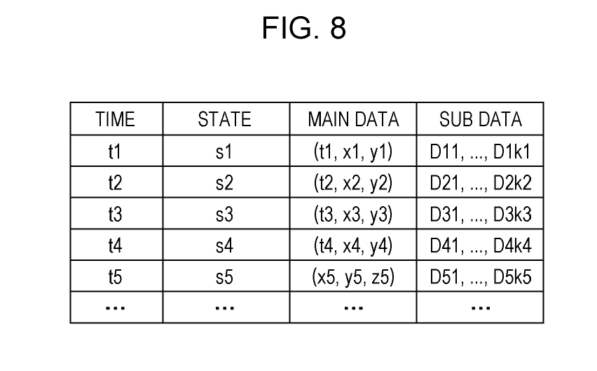

First, when a cell ID as sub data is detected, the detected cell ID is converted into a predetermined serial number. Serial numbers start from 1 and are sequentially assigned, for example, every time new cell IDs are detected, and time series data pieces of cell IDs are converted to time series data pieces with serial numbers. As a result, in a database that stores data for deciding parameters of the learning model, times, main data and sub data acquired at the times, and time series data of state IDs at those times are stored as shown in FIG. 8.

Next, based on the database shown in FIG. 8, an appearance frequency of a serial number corresponding to a cell ID is calculated for each state ID appearing in the database. Since the calculated appearance frequency of the serial number can be converted into a probability by being divided by the total number of appearances of the state ID, the state table of discrete symbols shown in FIG. 6 can be generated for serial numbers corresponding to cell IDs.

Note that, since a communication base station can detect a serving cell and one or more neighbor cells at each time, a plurality of cell IDs are detected as sub data. Herein, if a table in which the IDs of base stations are matched with addresses (latitude and longitude) indicating the location of the base stations can be acquired, a current location of a user can be estimated using the table, the detected plurality of cell IDs, and signal intensities. In this case, since the current location as the estimation result is of continuous symbols, not of discrete symbols, a state table of serial numbers corresponding to the cell IDs has the form for continuous symbols shown in FIGS. 7A and 7B, not the form for discrete symbols shown in FIG. 6.

As in the above manner, the parameters of the Hidden Markov Model calculated based on time series data of the past are stored in the model storage unit 19 in advance in the forms as shown in FIGS. 5 to 7B.

### Configuration of the Measurement Entropy Calculation Unit 14

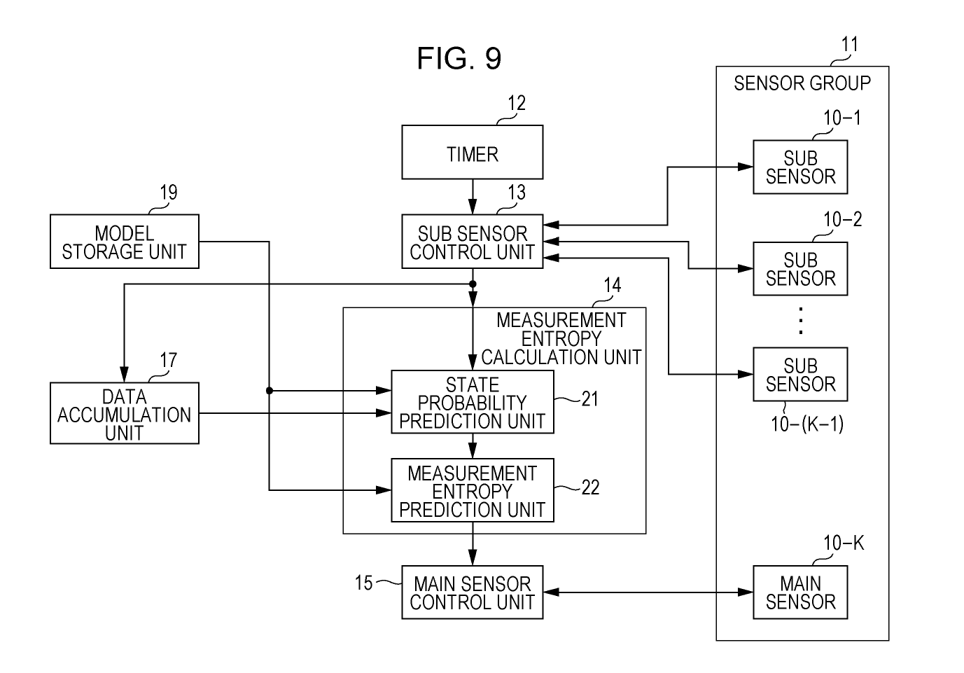

FIG. 9 is a block diagram only showing portions relating to control of the main sensor 10 in the configuration of the measurement control system 1 shown in FIG. 1.

The measurement entropy calculation unit 14 can be conceptually divided into a state probability prediction unit 21 that predicts a probability distribution of a state of the Hidden Markov Model and a measurement entropy prediction unit 22 that predicts the difference of information entropies.

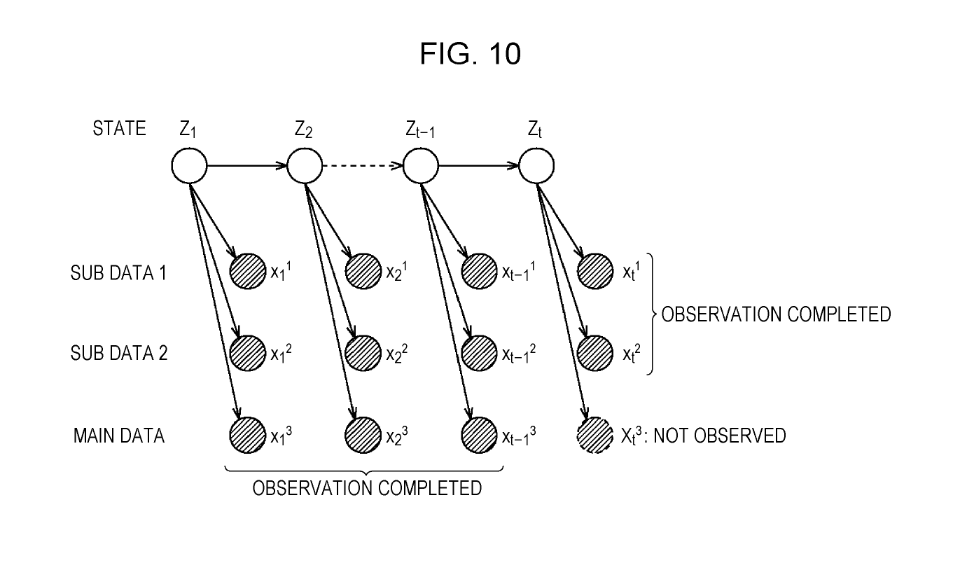

FIG. 10 shows a graphical model describing a process of the measurement entropy calculation unit 14.

The graphical model of the Hidden Markov Model is a model in which a state Zₜ of a time (step) t is probabilistically determined using a state Zₜ₋₁ of a state t−1 (a Markov property), and an observation Xₜ of the time t is probabilistically determined using only the state Zₜ.

FIG. 10 is an example in which whether or not the main sensor is operated is determined based on two types of sub data. x₁¹, x₂¹, x₃¹, . . . indicate first sub data pieces (sub data 1), x₁², x₂², x₃², . . . indicate second sub data pieces (sub data 2), and x₁³, x₂³, x₃³, . . . indicate main data pieces. The subscripts of each data piece x indicate times, and the superscripts thereof indicate numbers for identifying the type of data.

In addition, the lowercase x indicates data for which measurement has been completed, and the uppercase X indicates data for which measurement has not been completed. Thus, at a time t, the sub data 1 and 2 have been measured, but the main data has not been measured.

In the state as shown in FIG. 10, the measurement entropy calculation unit 14 sets time series data accumulated to the previous time t−1 and sub data pieces xₜ¹ and xₜ² measured by the sub sensors 10 at the time t to be input data of the Hidden Markov Model. Then, the measurement entropy calculation unit 14 decides whether or not a main data piece Xₜ³ of the time t is measured by operating the main sensor 10 using the Hidden Markov Model.

Note that the time series data accumulated to the previous time t−1 is supplied to the measurement entropy calculation unit 14 from the data accumulation unit 17. In addition, the sub data pieces xₜ¹ and xₜ² measured by the sub sensors 10 at the time t are supplied to the measurement entropy calculation unit 14 from the sub sensor control unit 13. In addition, the parameters of the Hidden Markov Model are supplied to the measurement entropy calculation unit 14 from the model storage unit 19.

The state probability prediction unit 21 of the measurement entropy calculation unit 14 predicts a probability distribution P(Zₜ) of the state Zₜ at the time t for each case in which the main data piece Xₜ³ of the time t is measured and not measured. The measurement entropy prediction unit 22 calculates the difference of the information entropies using the probability distribution P(Zₜ) of each case in which the main data piece Xₜ³ of the time t is measured and not measured.

### State Probability Prediction Unit 21

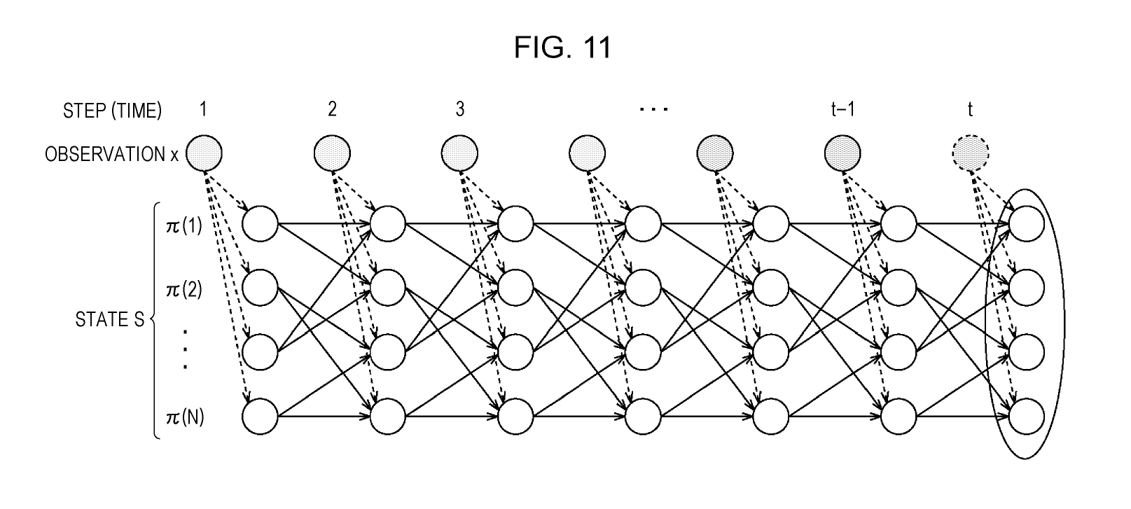

FIG. 11 is a trellis diagram describing prediction calculation of the probability distribution P(Zₜ) of the state Zₜ at the time t by the state probability prediction unit 21.

In FIG. 11, the white circles indicate states of the Hidden Markov Model, and four states are prepared in advance. The gray circles indicate observations (measured data). A step (time) t=1 indicates an initial state, and state transitions that can be implemented in each step (time) are shown by solid-lined arrows.

The probability distribution P(Z₁) of each state in the step t=1 of the initial state is given as an equal probability as in, for example, Formula (1).

P(Z₁)=1/N (1)

In Formula (1), Z₁ is the ID of the state (internal state) in the step t=1, and hereinafter, a state in a step t of ID=Zₜ is referred to simply as a state Zₜ. The N of Formula (1) indicates the number of states of the Hidden Markov Model.

Note that, when an initial probability π(Z₁) of each state is given, P(Z₁)=π(Z₁) can be satisfied using the initial probability π(Z₁). In most cases, the initial probability is held as a parameter in the Hidden Markov model.

The probability distribution P(Zₜ) of the state Zₜ in the step t is given in a recurrence formula using a probability distribution P(Zₜ₋₁) of a state Zₜ₋₁ in a step t−1. Then, the probability distribution P(Zₜ₋₁) of the state Zₜ₋₁ in the step t−1 can be indicated by a conditional probability when a measured data piece x_{1:t-1} from the step 1 to the step t−1 is known. In other words, the probability distribution P(Zₜ₋₁) of the state Zₜ₋₁ in the step t−1 can be expressed by Formula (2).

P(Zₜ₋₁)=P(Zₜ₋₁|x_{1:t-1})Zₜ₋₁=1, . . . , and n) (2)

In Formula (2), x_{1:t-1} indicates known measured data x from the step 1 to the step t−1. The right side of Formula (2) is more precisely P(Zₜ₋₁|X_{1:t-}1=x_{1:t-1}).

In the state Zₜ in the step t, a probability distribution (prior probability) before measurement P(Zₜ)=P(Zₜ|x_{1:t-1}) is obtained by updating the probability distribution P(Zₜ₋₁) of the state Zₜ₋₁ in the step t−1 using a transition probability P(Zₜ|Zₜ₋₁)=aᵢⱼ. In other words, the probability distribution (prior probability) when measurement is not performed, which is P(Zₜ)=P(Zₜ|x_{1:t-1}), can be expressed by Formula (3). Note that the above-described transition probability aᵢⱼ is a parameter held in the transition table of FIG. 6.

$$P ( {Z}_{t} ) = P ( {Z}_{t} \vert {x}_{1 : t - 1} ) = {\sum }_{{Z}_{t - 1} = 1}^{N} P ( {Z}_{t} \vert {Z}_{t - 1} ) P ( {Z}_{t - 1} ) \qquad ( 3 )$$

Formula (3) indicates a process in which the probabilities of all state transitions up to the state Zₜ in the step t are added together.

Note that, instead of Formula (3), the following Formula (3′) can also be used.

P(Zₜ)=max_{Z}_{ₜ₋₁}(P(Zₜ|Zₜ₋₁)P(Zₜ₋₁))/Ω (3′)

Herein, Ω is a standardized constant of a probability of Formula (3′). Formula (3′) is used when it is important to select only a transition with the highest occurrence probability out of state transitions in each step rather than to select an absolute value of a probability, for example, when a state transition series with the highest occurrence probability such as the Viterbi algorithm is desired to know.

On the other hand, if an observation Xₜ is obtained from measurement, a probability distribution P(Zₜ|Xₜ) of a conditional probability (posterior probability) of the state Zₜ under the condition in which the observation Xₜ is obtained can be acquired. In other words, the posterior probability P(Zₜ|Xₜ) from measurement of the observation Xₜ can be expressed as follows.

$$P ( {Z}_{t} \vert {X}_{t} ) = \frac{P ( {X}_{t} \vert {Z}_{t} ) P ( {Z}_{t} )}{{\sum }_{{Z}_{t} = 1}^{N} P ( {X}_{t} \vert {Z}_{t} ) P ( {Z}_{t} )} \qquad ( 4 )$$

Wherein, the observation Xₜ expressed in the uppercase in the step t is data that has not been measured, and indicates a probability variable.

As shown in Formula (4), the posterior probability P(Zₜ|Xₜ) from the measurement of the observation Xₜ can be expressed using a likelihood P(Xₜ|Zₜ) of the state Zₜ generating the observation Xₜ and the prior probability P(Zₜ) based on Bayes' theorem. Herein, the prior probability P(Zₜ) is known by the recurrence formula of Formula (3). In addition, the likelihood P(Xₜ|Zₜ) of the state Zₜ generating the observation Xₜ is a parameter p_{xt,zt} of the state table of the Hidden Markov Model of FIG. 6 if the observation Xₜ is a discrete variable.

In addition, if the observation Xₜ is a continuous variable and components of each dimension j are modeled when following the normal distribution of the center of μᵢⱼ=cᵢⱼ, and a variance of σᵢⱼ²=vᵢⱼ that are decided in advance for each state i=Zₜ, the likelihood is as follows.

$$P ( {X}_{t} \vert {Z}_{t} ) = {\prod }_{j = 1}^{D} N ( {X}_{t} \vert {μ}_{ij} , {σ}_{ij}^{2} )$$

Wherein, cᵢⱼ and vᵢⱼ that are used as parameters of the center and variance are parameters of the state table shown in FIGS. 7A and 7B.

Thus, if a probability variable Xₜ is found (if the probability variable Xₜ becomes a normal variable xₜ from measurement), Formula (4) can be easily calculated, and a posterior probability on the condition in which time series data up to the observation Xₜ is obtained can be calculated.

A formula of updating a probability in the Hidden Markov Model is expressed by an updating rule of Formula (4) in which the data xₜ at a current time t is known. In other words, the formula of updating the probability of the Hidden Markov Model is expressed by a formula in which the observation Xₜ of Formula (4) is replaced by the data xₜ. However, the measurement entropy calculation unit 14 desires to acquire a probability distribution of a state before measurement at the current time t is performed. In such a case, a formula in which P(Xₜ|Zₜ) of the updating rule in Formula (4) is set to “1” can be used. In other words, the formula in which P(Xₜ|Zₜ) of Formula (4) is set to “1” is Formula (3) or (3′), and corresponds to the prior probability P(Zₜ) before measurement at the time t is performed.

In addition, the above can be applied in the same manner also to a case in which data missing occurs in time series data of the past from the time 1 prior to the current time to the time t−1. In other words, when data missing occurs in the time series data, P(X|Z) of the data missing portion in the updating formula of Formula (4) can be substituted by “1” for calculation (since the time of the data missing portion is not specified, subscripts of P(X|Z) are omitted).

Note that the above-described observation Xₜ in the step t corresponds to the entire data obtained from K sensors 10 including the main sensor 10 and the sub sensors 10 together, and in order to discriminate the K sensors, the observation Xₜ corresponding to data obtained from k-th (k=1, 2, . . . , and K) sensor 10 is described as an observation Xₜ^{k}. In this case, by setting the K−1 sub sensors 10 to be sequentially operated in a predetermined order decided in advance, and when K−1 sub sensors 10 perform measurement and thereby an observation Xₜ^{1:K-1}=xₜ¹, xₜ², . . . , and xₜ^{K-1} of the time t and measured data x_{1:t-1} of the K sensors 10 from the time 1 to the time t−1 are obtained at the time t, if a prior probability before the K-th main sensor 10 is operated is set to P(Zₜ|xₜ^{1:K-1})=P(Zₜ|x^{1:t-1}, xₜ^{1:K-1}), the prior probability P(Zₜ|xₜ^{1:K-1}) is given using the following Formula (5).

$$\begin{matrix}P ( {Z}_{t} \vert {x}_{t}^{1 : K - 1} ) = \frac{P ( {x}_{t}^{1 : K - 1} \vert {Z}_{t} ) P ( {Z}_{t} )}{{\sum }_{{Z}_{t} = 1}^{N} P ( {x}_{t}^{1 : K - 1} \vert {Z}_{t} ) P ( {Z}_{t} )} \\ = \frac{{\prod }_{k = 1}^{K - 1} P ( {x}_{t}^{k} \vert {Z}_{t} ) P ( {Z}_{t} )}{{\sum }_{{Z}_{t} = 1}^{N} {\prod }_{k = 1}^{K - 1} P ( {x}_{t}^{k} \vert {Z}_{t} ) P ( {Z}_{t} )}\end{matrix} \qquad ( 5 )$$

Formula (5) is a formula obtained by rewriting the prior probability P(Zₜ) of the above-described Formula (3) with respect to the K-th main sensor 10, predicting the probability distribution P(Zₜ) of the state Zₜ at the time t when measurement by the main sensor 10 is not performed.

On the other hand, if a posterior probability that an observation Xₜ^{K} is measured using the K-th main sensor 10 is set to P(Zₜ|xₜ^{K})=P(Zₜ|xₜ^{1:K-1}, xₜ^{K}), the posterior probability P(Zₜ|xₜ^{1:K-1}, xₜ^{K}) is given using the following Formula (6).

$$P ( {Z}_{t} \vert {x}_{t}^{1 : K - 1} , {X}_{t}^{K} ) = \frac{ P ( {X}_{t}^{k} \vert {Z}_{t} ) P ( {Z}_{t} )}{{\sum }_{{Z}_{t} = 1}^{N} P ( {X}_{t}^{k} \vert {Z}_{t} ) P ( {Z}_{t} )} \qquad ( 6 )$$

Formula (6) is a formula obtained by rewriting the posterior probability P(Zₜ|xₜ) of the above-described Formula (4) with respect to the K-th main sensor 10, predicting the probability distribution P(Zₜ) of the state Zₜ at the time t when measurement by the main sensor 10 is performed.

Note that, when Formula (6) is calculated, there are cases in which data missing occurs in the time series data of the past. In such a case, “1” is substituted for P(X|Z) of the data missing portion (since the type of a sensor and the time of the data missing portion are not specified, the subscripts and superscripts of P(X|Z) are omitted).

P(Xₜ^{K}|Zₜ) of Formula (6) is a likelihood of obtaining the observation Xₜ of the state Zₜ with respect to the K-th main sensor 10. The likelihood of P(Xₜ^{K}|Zₜ) is obtained as an observation probability that the observation Xₜ is observed from the state Zₜ using the state table of FIG. 6 when the observation Xₜ is a discrete symbol. In addition, when the observation Xₜ is a continuous symbol, and follows a normal distribution given in advance, the probability of P(Xₜ^{K}|Zₜ) is given as probability density in an observation X of a normal distribution defined with the center values and the variance values of FIGS. 7A and 7B given to the state Zₜ in advance.

### Measurement Entropy Prediction Unit 22

The measurement entropy prediction unit 22 decides to operate the main sensor 10 when an information amount obtained from measurement by the main sensor 10 is great. In other words, when ambiguity when measurement is not performed can be reduced by performing measurement in the main sensor 10, the measurement entropy prediction unit 22 decides to operate the main sensor 10. This ambiguity is unclearness in a probability distribution, and can be expressed by information entropies that the probability distribution has.

An information entropy H(Z) is generally expressed by the following Formula (7).

H(Z)=−∫dZP(Z)log P(Z)=−ΣP(Z)log P(Z) (7)

The information entropy H(Z) is expressed by an integration indication in the entire space of Z if the interval variable Z is continuous, and can be expressed by an addition indication for all Zs if the internal variable Z is discrete.

In order to calculate the difference of the information amounts when measurement is performed and not performed by the main sensor 10, first, each of the information amounts when measurement by the main sensor 10 is performed and when measurement by the main sensor 10 is not performed is considered.

Since the prior probability P(Zₜ) when measurement by the main sensor 10 is not performed can be expressed by Formula (5), an information entropy H_{b} when measurement by the main sensor 10 is not performed can be expressed by Formula (8) using Formula (5).

$$\begin{matrix}{H}_{b} = H ( {Z}_{t} ) \\ = - {\sum }_{{Z}_{t} = 1}^{N} P ( {Z}_{t} \vert {x}_{t}^{1 : K - 1} ) log P ( {Z}_{t} \vert {x}_{t}^{1 : K - 1} ) \\ = - {\sum }_{{Z}_{t} = 1}^{N} P ( {Z}_{t} ) log P ( {Z}_{t} )\end{matrix} \qquad ( 8 )$$

In the formula in the final line of Formula (8), description of conditioning with an observation result xₜ^{1:K-1} by K−1 sub sensors 10 is omitted in order to avoid complexity. The information amount when measurement by the main sensor 10 is not performed is an information amount computed from a probability distribution in which a posterior probability P(Zₜ₋₁|xₜ₋₁) of state variables of the Hidden Markov Model obtained from time series data up to the previous measurement and a prior probability P(Zₜ|xₜ) of the state Zₜ at the current time t obtained from a transition probability of the state variables of the Hidden Markov Model.

On the other hand, the posterior probability P(Zₜ|xₜ^{K}) when measurement by the main sensor 10 is performed can be expressed by Formula (6), but the observation xₜ^{K} is a probability variable since it has not been measured in reality. Thus, it is necessary to obtain an information entropy Hₐ when measurement by the main sensor 10 is performed under the condition of the distribution of the observation variable xₜ^{K}. In other words, the information entropy Hₐ when measurement by the main sensor 10 is performed can be expressed by Formula (9).

$$\begin{matrix}{H}_{a} = {E}_{{X}_{t} k} [ H ( {Z}_{t} ) ] \\ = H ( {Z}_{t} \vert {X}_{t}^{K} ) \\ = - \int d {X}_{t}^{K} P ( {X}_{t}^{K} ) {\sum }_{{Z}_{t} = 1}^{N} P ( {Z}_{t} \vert {x}_{t}^{1 : K - 1} , {X}_{t}^{K} ) log P ( {Z}_{t} \vert {x}_{t}^{1 : K - 1} {X}_{t}^{K} ) \\ = - \int d {X}_{t}^{K} {\sum }_{{Z}_{t} = 1}^{N} P ( {X}_{t}^{K} \vert {Z}_{t} ) P ( {Z}_{t} ) log \frac{P ( {X}_{t}^{K} \vert {Z}_{t} ) P ( {Z}_{t} )}{{\sum }_{{Z}_{t}^{′} = 1}^{N} P ( {X}_{t}^{K} \vert {Z}_{t}^{′} ) P ( {Z}_{t}^{′} )}\end{matrix} \qquad ( 9 )$$

The formula in the first line of Formula (9) shows that an information entropy of the posterior probability under the condition that the observation Xₜ^{K} is obtained is acquired as an expectation value for the probability variable Xₜ^{K}. However, this formula is equal to a definitional formula of the conditional information entropy for the state Zₜ under the condition that the observation Xₜ^{K} is obtained, it can be expressed as the formula in the second line. The formula in the third line is a formula obtained by developing the formula in the second line according to Formula (7), and the formula in the fourth line is a formula in which description of conditioning for the observation result xₜ^{1:K-1} from the K−1 sub sensors 10 is omitted, the same as the final line of Formula (8).

The information amount when measurement by the main sensor 10 is performed is an information amount obtained in such a way that data obtained from measurement is expressed by the observation variable Xₜ, an information amount that can be computed from the posterior probability P(Zₜ|Xₜ) of the state Zₜ of the Hidden Markov Model under the condition that the observation variable Xₜ is obtained is obtained by computing an expectation value for the observation variable Xₜ.

Based on the above, the difference ΔH of the information entropies when measurement is performed and not performed by the main sensor 10 can be expressed as follows using Formulas (8) and (9).

$$\begin{matrix}Δ H = {H}_{a} - {H}_{b} \\ = H ( {Z}_{t} \vert {X}_{t}^{K} ) - H ( {Z}_{t} ) \\ = - I ( {Z}_{t} ; {X}_{t}^{K} ) \\ = - \int d {X}_{t}^{K} {\sum }_{{Z}_{t} = 1}^{N} P ( {X}_{t}^{K} \vert {Z}_{t} ) P ( {Z}_{t} ) log \frac{P ( {X}_{t}^{K} \vert {Z}_{t} ) P ( {Z}_{t} )}{{\sum }_{{Z}_{t}^{′} = 1}^{N} P ( {X}_{t}^{K} \vert {Z}_{t}^{′} ) P ( {Z}_{t}^{′} )} + \\ {\sum }_{{Z}_{t} = 1}^{N} P ( {Z}_{t} ) log P ( {Z}_{t} ) \\ = - \int d {X}_{t}^{K} {\sum }_{{Z}_{t} = 1}^{N} P ( {X}_{t}^{K} \vert {Z}_{t} ) P ( {Z}_{t} ) log \frac{P ( {X}_{t}^{K} \vert {Z}_{t} )}{{\sum }_{{Z}_{t}^{′} = 1}^{N} P ( {X}_{t}^{K} \vert {Z}_{t}^{′} ) P ( {Z}_{t}^{′} )}\end{matrix} \qquad ( 10 )$$

The formula in the second line of Formula (10) shows that the difference ΔH of the information entropies is equal to the result obtained by multiplying a mutual information amount I(Zₜ; Xₜ) of the state Zₜ and the observation Xₜ^{K} of the Hidden Markov Model by −1. The formula in the third line of Formula (10) is obtained by substituting the above-described Formulas (8) and (9) for the formula, and the formula in the fourth line of Formula (10) is obtained by organizing the formula in the third line. The difference ΔH of the information entropies is the reduced amount of ambiguity in the state variable, but the mutual information amount I obtained by multiplying the amount by −1 can be taken as an information amount necessary for resolving the ambiguity.

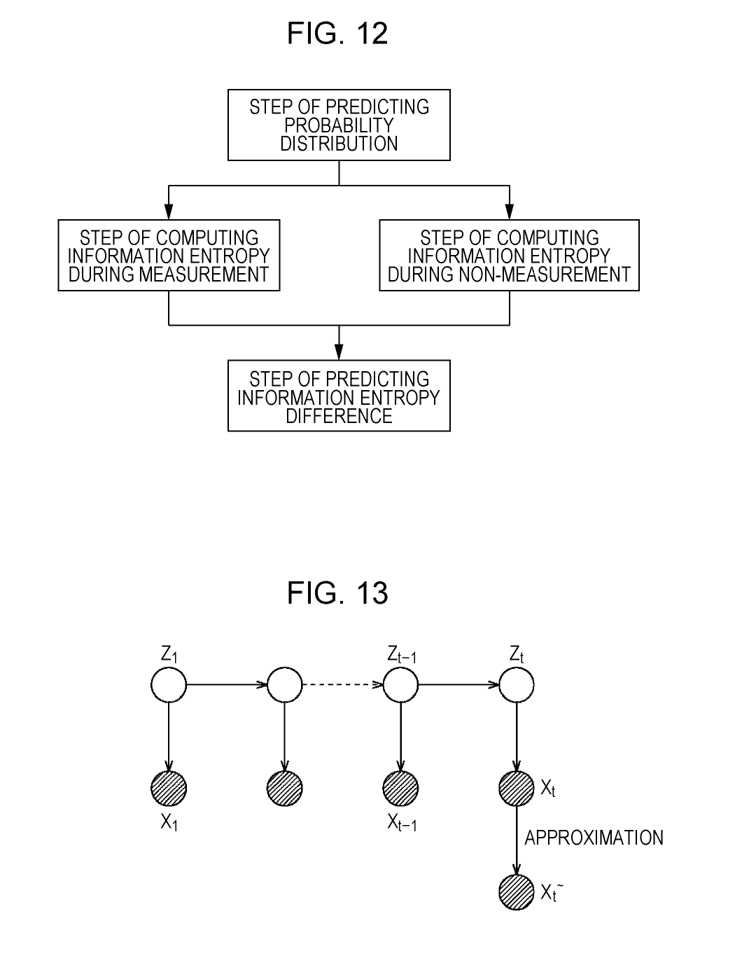

As described above, the probability distribution P(Zₜ) of the state Zₜ is predicted using Formulas (5) and (6) as a first step, information entropies when measurement is performed and not performed are computed using Formulas (8) and (9) as a second step, and finally, the difference ΔH of the information entropies is obtained in a sequential manner as shown in FIG. 12.

However, since the difference ΔH of the information entropies of Formula (10) may be finally obtained in order to decide whether or not the main sensor 10 is operated, the measurement entropy calculation unit 14 is configured to directly compute the difference ΔH of the information entropies of Formula (10). Accordingly, the process to compute the difference ΔH of the information entropies can be made to be easy.

In the above-description, however, the case in which the probability distribution P(Zₜ) and the difference ΔH of the information entropies are calculated to decide whether or not the main sensor 10, which is the K-th sensor, is to be operated has been described in the premise that measured data of the time t by K−1 sub sensors 10 is obtained.

However, to cause the K−1 sub sensors 10 to sequentially perform measurement in a predetermined order, by replacing the variable K in the above-described Formulas (5), (6), and (8) to (10) with k (<K), a process of determining whether or not the sub sensor 10 operated in k-th order is operated can apply using data measured by k−1 sub sensors 10 to that time.

Herein, in what order the K−1 sub sensors 10 should be operated will be described.

The order of operating the K−1 sub sensors 10 can be set to an ascending order of measurement costs. Accordingly, the measurement costs can be suppressed to the minimum level by causing a plurality of sub sensors 10 to be operated in an ascending order of the measurement costs.

The measurement costs can be set as, for example, consumption power of a battery when the sub sensors 10 are operated. For the measurement costs, if “1” is given to consumption power of a battery of the main sensor 10, an acceleration sensor is “0.1”, a wireless LAN radio wave intensity sensor is “0.3”, a mobile radio wave intensity sensor is “0”, and the like, and they are stored in a memory inside the measurement entropy calculation unit 14. Since the mobile radio wave intensity sensor is operated regardless of the operation control of the main sensor 10, “0” is given to the sensor. In addition, based on the measurement costs stored in the memory inside the measurement entropy calculation unit 14, by sequentially operating the sub sensors 10 in the ascending order of the measurement costs so as to calculate Formulas (5) and (6) in which the variable K is replaced by k (<K), it is possible to determine whether or not a k-th sub sensor 10 incurring the next lower measurement cost is operated.

Note that, without merely using the ascending order of the measurement costs, sensors may be operated in order of lower measurement costs and greater information amounts obtained from measurement by adding the size of information amounts obtained from measurement. In addition, the measurement costs may not be fixed at all times, and may be changed with a predetermined condition so as to set the main sensor 10 and the sub sensors 10 to switch with each other.

### Approximate Calculation of the Difference ΔH of the Information Entropies

The calculation of the difference ΔH of the information entropies expressed in Formula (10) can be realized through enumeration if the observation Xₜ is a probability variable in a discrete data space. However, when the observation Xₜ is a probability variable in a continuous data space, it is necessary to fold an integration so as to obtain the difference ΔH of the information entropies. Since it is difficult for the integration in this case to analytically process a normal distribution having many peaks included in Formula (10), it has to be dependent on a numerical integration such as Monte Carlo integration, or the like. However, the difference ΔH of the information entropies is originally of an arithmetic operation in computation of an effect of measurement for reducing measurement costs, and it is not preferable that an arithmetic operation such as a numerical integration, or the like, having a high processing load be not included in the foregoing arithmetic operation. Therefore, in the computation of the difference ΔH of the information entropies of Formula (10), it is desirable to avoid a numerical integration.

Thus, hereinbelow, an approximate calculation method to avoid a numerical integration in the computation of the difference ΔH of the information entropies will be described.

In order to avoid taking costs to calculate Formula (10) due to the fact that the observation Xₜ is a continuous variable, an observation Xₜ^{˜} expressed as a discrete probability variable that is newly generated from the continuous probability variable Xₜ is introduced as shown in FIG. 13.

FIG. 13 is a diagram conceptually showing approximation by the observation Xₜ^{˜} expressed as a discrete probability variable that is newly generated from the continuous probability variable Xₜ. However, FIG. 13 shows the entire measured data by the K sensors 10 in FIG. 10 in the observation Xₜ.

If the discrete probability variable Xₜ^{˜} is used as above, Formula (10) can be modified into Formula (11).

$$\begin{matrix}Δ H ≅ Δ \tilde{H} \\ ≡ - I ( {Z}_{t} ; {X}_{t}^{{K}^{∼}} ) \\ = - {\sum }_{{X}_{t}^{{K}^{∼}}} {\sum }_{{Z}_{t} = 1}^{N} P ( {X}_{t}^{{K}^{∼}} \vert {Z}_{t} ) P ( {Z}_{t} ) log \frac{P ( {X}_{t}^{{K}^{∼}} \vert {Z}_{t} )}{{\sum }_{{Z}_{t}^{′} = 1}^{N} P ( {X}_{t}^{{K}^{∼}} \vert {Z}_{t}^{′} ) P ( {Z}_{t}^{′} )}\end{matrix} \qquad ( 11 )$$

According to Formula (11), since the integration can be replaced by adding the entire elements up, integration calculation having a high processing load can be avoided.

However, since the continuous variable Xₜ^{K} is replaced by the discrete variable Xₜ^{K˜} herein, reduction in an information amount can be easily imagined. In reality, the following inequality is generally satisfied between an information entropy obtained in Formula (10) and an information entropy obtained in Formula (11), the information entropies decrease to an approximate value.

I(Zₜ;Xₜ^{K˜})≦I(Zₜ;Xₜ^{K}) (12)

Note that the sign of equality of Formula (12) is satisfied only when Xₜ^{K}=Xₜ^{K˜} is satisfied. Thus, the sign of equality is not satisfied when the continuous variable Xₜ^{K} is substituted by the discrete variable Xₜ^{K˜}.

When the continuous variable Xₜ^{K} is substituted by the discrete variable Xₜ^{K˜} (variable conversion), it is desirable to make Xₜ^{K} and Xₜ^{K˜} correspond to each other as close as possible to reduce the difference between both sides of the inequality of Formula (12). Thus, in order to reduce the difference between both sides of the inequality of Formula (12), the discrete variable Xₜ^{K˜} is defined as a discrete variable having the same symbol as the state variable Z. In other words, any method of substituting the continuous variable Xₜ^{K} with the discrete variable Xₜ^{K˜} may be used, but efficient variable conversion can be performed by converting the variable into the state variable Z of the Hidden Markov Model in which time series data is efficiently learned.

With respect to the discrete variable Xₜ^{K˜}, the probability of observing Xₜ^{K˜} when X is given is given as follows.

$$P ( {X}^{\sim} \vert X ) = \frac{P ( X \vert {X}^{\sim} , λ )}{{\sum }_{{X}^{\sim} = 1}^{N} P ( X \vert {X}^{\sim} , λ )} \qquad ( 13 )$$

Herein, λ is a parameter for deciding a probability (probability density) in which an observation X is observed in a state Z. Based on the fact, Formula (13) can be expressed as follows.

$$\begin{matrix}P ( {X}^{\sim} \vert Z ) = \frac{P ( {X}^{\sim} , Z )}{P ( Z )} \\ = \int d X \frac{P ( {X}^{\sim} , X , Z )}{P ( Z )} \\ = \int d XP ( {X}^{\sim} \vert X ) P ( X \vert Z ) \\ = \int d X \frac{P ( X \vert {X}^{\sim} ) P , ( {X}^{\sim} \vert Z )}{{\sum }_{{X}^{\sim} = 1}^{N} P ( X \vert {X}^{\sim} )}\end{matrix} \qquad ( 14 )$$

If the probability density to generate the observation X in the state Z is set to follow a normal distribution and the dimension of the observation X is set to D-dimension, data obtained from the state Z=i follows the normal distribution of the center value cᵢⱼ and the variance value vᵢⱼ for j-dimensional components, Formula (14) is written as follows.

$$P ( {X}^{\sim} \vert Z ) = {\prod }_{d = 1}^{D} {\int }_{- ∞}^{∞} d {X}_{d} \frac{N ( {X}_{d} \vert {c}_{id} , {v}_{id} ) N ( {X}_{d} \vert {c}_{jd} , {v}_{jd} )}{{\sum }_{j = 1}^{N} N ( {X}_{d} \vert {c}_{jd} , {v}_{jd} )} \qquad ( 15 )$$

Herein, N(x|c,v) is probability density of x of the normal distribution of the center c and the variance v shown in FIGS. 7A and 7B.

Formula (15) includes a normal distribution having many peaks in the denominator, and it is difficult to analytically obtain the formula in general. Thus, in the same manner as when the difference ΔH of the information entropies of Formula (10) is calculated, it is necessary to obtain a numerical value using the Monte Carlo integration, or the like that use normally distributed random numbers.

However, it is not necessary to execute the calculation of Formula (15) every time before measurement is performed as when Formula (10) is obtained. Formula (15) may be calculated only once at the time of first construction of the Hidden Markov Model or model updating, and a table that retains the result is stored so as to be substituted for Formula (11) if necessary.

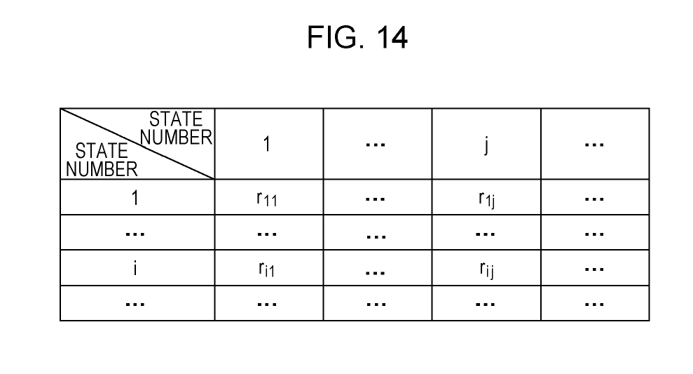

FIG. 14 shows an example of a variable conversion table that is a table in which observation probabilities of obtaining the discrete variable Xₜ^{K˜} are retained for each state Z, as the calculation result of Formula (15).

A state number i of FIG. 14 corresponds to the state Z of Formula (15), and a state number j of FIG. 14 corresponds to the discrete variable Xₜ^{K˜} of Formula (15). In other words, P(Xₜ^{K˜}|Z) of Formula (15) is P(j|i)=P(Xₜ^{K˜}=j|Z=i) in FIG. 14, and P(j|i)=rᵢⱼ.

Note that, in the general Hidden Markov Model, such a variable conversion table is not necessary. Of course, if there is a room in calculation resources to the extent that Formula (10) can be calculated by numerical calculation, such a variable conversion table is not necessary. This variable conversion table is used when a strict approximation of Formula (10) to a certain degree is performed when there are not calculation resources sufficient for executing numerical integration.

In addition, for an element rᵢⱼ in this variable conversion table, parameters of which the quantity is a square of the number of state are necessary. However, the element rᵢⱼ in this variable conversion table becomes 0 in most cases particularly in a mode in which there is little overlapping and hiding in a data space. Thus, in order to omit memory resources, simplification can be variously performed in such a way that only elements of a variable conversion table which are not 0 are stored, only super-ordinate elements having high values in each line are stored, all elements are made to be the same constant, or the like. The most audacious simplification is to set that rᵢⱼ=δᵢⱼ on the assumption that states i and j seldom occupy the same data space. δᵢⱼ is Kronecker delta, and becomes 1 when i=j is satisfied, and 0 in other cases. In this case, Formula (11) is simplified without limit so as to be expressed as Formula (16).

$$\begin{matrix}Δ H ≅ Δ \tilde{H} \\ ≡ - I ( {Z}_{t} ; {X}_{t}^{{K}^{∼}} ) \\ = {\sum }_{{Z}_{t} = 1}^{N} P ( {Z}_{t} ) log P ( {Z}_{t} )\end{matrix} \qquad ( 16 )$$

Formula (16) means that a prediction entropy after measurement is 0, and an information amount that can be acquired through measurement only with a prediction entropy before measurement is estimated. In other words, Formula (16) assumes that the entropy after measurement becomes 0 since states are necessarily uniformly decided when measurement is performed by setting that rᵢⱼ=δᵢⱼ. In addition, with regard to Formula (16), if the ambiguity of data before measurement is high, the value of Formula (16) increases, and an information amount that can be acquired from measurement becomes large, but if the ambiguity of data before measurement is low, the value of Formula (16) decreases, which means that the ambiguity can be sufficiently resolved only from prediction without performing measurement.

### Flowchart of a Sensing Control Process

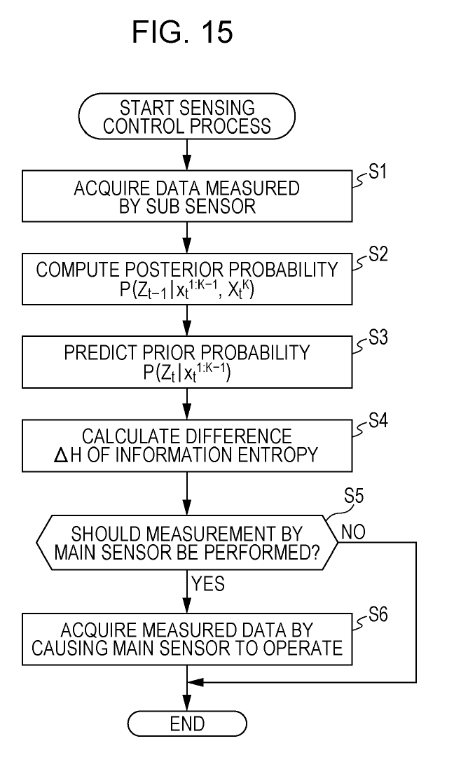

Next, with reference to the flowchart of FIG. 15, a sensing control process in which turning on and off of the main sensor 10 are controlled by the measurement control system 1 will be described. Note that it is assumed that parameters of the Hidden Markov Model as a learning model are acquired from the model storage unit 19 by the measurement entropy calculation unit 14 prior to this process.

In Step S1, first, the sub sensor control unit 13 acquires measured data that is measured by the K−1 sub sensors 10 at the time t, and then supplies the data to the data accumulation unit 17 and the measurement entropy calculation unit 14. The data accumulation unit 17 stores the measured data supplied from the sub sensor control unit 13 as times series data.

In Step S2, the measurement entropy calculation unit 14 computes a posterior probability P(Zₜ₋₁|xₜ^{1:K-1}, Xₜ^{K}) obtained by performing measurement of the observation Xₜ^{K} in the main sensor 10 under the condition in which the measured data xₜ^{1:K-1} is obtained at the time t by the K−1 sub sensors 10 using Formula (6).

In Step S3, the measurement entropy calculation unit 14 predicts a prior probability P(Zₜ|xₜ^{1:K-1}) before measurement at the current time t is performed by the main sensor 10 that is the K-th sensor using Formula (5).

In Step S4, the measurement entropy calculation unit 14 calculates the difference ΔH of information entropies when measurement by the main sensor 10 is performed and not performed using Formula (10). Alternatively, as Step S4, by performing calculation of Formula (11) or (16) using the variable conversion table of FIG. 14 which is approximate calculation of Formula (10), the measurement entropy calculation unit 14 calculates the difference ΔH of the information entropies when measurement the main sensor 10 is performed and not performed.

In Step S5, by determining whether or not the calculated difference ΔH of the information entropies is lower than or equal to a predetermined threshold value I_{TH}, the measurement entropy calculation unit 14 determines whether or not measurement by the main sensor 10 should be performed.

When the difference ΔH of the information entropies is lower than or equal to the threshold value I_{TH}, and measurement by the main sensor 10 is determined to be performed in Step S5, the process proceeds to Step S6, and the measurement entropy calculation unit 14 determines to operate the main sensor 10, and supplies the determination to the main sensor control unit 15. The main sensor control unit 15 controls the main sensor 10 to operate so as to acquire measurement data from the main sensor 10. The acquired measurement data is supplied to the data storage unit 17.

On the other hand, when the difference ΔH of the information entropies is greater than the threshold value I_{TH}, and measurement by the main sensor 10 is determined not to be performed in Step S5, the process of Step S6 is skipped, and then the process ends.

The above process is executed at a given timing such as every time measured data by the sub sensors 10 is acquired, or the like.

In the above sensing control process, measurement by the main sensor 10 can be performed only when an information amount obtained from measurement by the main sensor 10 is large. In addition, when measurement by main sensor 10 is performed, measured data by the main sensor 10 is used, and when measurement by the main sensor 10 is not performed, data to be acquired by the main sensor 10 is estimated based on time series data accumulated prior to the time t and the measured data by the sub sensors 10 at the time t. Accordingly, the main sensor 10 can be driven and controlled so as to extract information to the maximum extent while reducing measurement costs.

Note that, in the above-described sensing control process, the threshold value I_{TH} used to determine whether or not the main sensor 10 is to be operated may be a fixed value decided in advance, or may be a variation value that varies according to the current margin of an index used to decide measurement costs. If the measurement costs are assumed to correspond to consumption power of a battery, for example, a threshold value I_{TH}(R) changes according to a remaining amount R of the battery, and when the remaining amount of the battery is low, the threshold value I_{TH} may be changed according to the remaining amount so that the main sensor 10 is not operated if an obtained information amount is not quite large. In addition, when the measurement costs correspond to a use rate of a CPU, the threshold value I_{TH} may be changed according to the use rate of the CPU, and when the use rate of the CPU is high, the main sensor 10 can be controlled not to be operated if an obtained information amount is not quite large, or the like.

Note that, as a method of controlling measurement by the main sensor 10 to reduce measurement costs, a method of lowering measurement accuracy of the main sensor 10 is also considered. For example, a method of controlling the main sensor 10 so as to change setting of a convergence time of approximate calculation that weakens intensity of measurement signals, or the like is considered in such a way that there are two or more operation levels in turning on the main sensor 10 and the operation levels are changed. When control to change the operation levels is performed in order to lower the measurement accuracy as above, it is desirable to perform the control so that the difference ΔH of information entropies measured according to the operation levels after the change is smaller than at least 0.

### Flowchart of Data Restoration Process

Next, a data restoration process executed by the data restoration unit 18 will be described.

When some of time series data accumulated for a given period of time or in a given amount are missing, the data restoration unit 18 restores the missing data by applying the Viterbi algorithm to the time series data in that time. The Viterbi algorithm is an algorithm to estimate the most likely state series from the given time series data and the Hidden Markov Model.

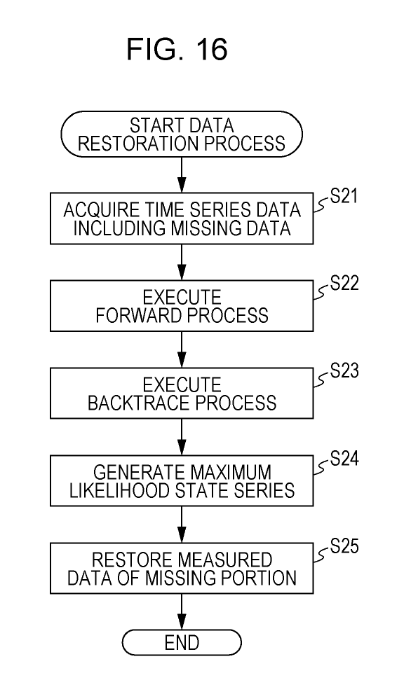

FIG. 16 is a flowchart of a data restoration process executed by the data restoration unit 18. This process is executed at a given timing, for example, a periodical timing such as one time a day, or a timing at which a learning model of the model storage unit 19 is updated.

First, in Step S21, the data restoration unit 18 acquires time series data that is newly accumulated in the data storage unit 17 as a measurement result of each of the sensors 10. Some of the time series data acquired herein include data missing.

In Step S22, the data restoration unit 18 executes a forward process. Specifically, the data restoration unit 18 computes a probability distribution of each state up to a step t from a step 1 in order with regard to t time series data pieces acquired in the time direction from the step 1 to the step t. The probability distribution of a state Zₜ in the step t is computed using the following Formula (17).

$$P ( {Z}_{t} \vert {x}_{t} ) = \frac{P ( {x}_{t} \vert {Z}_{t} ) P ( {Z}_{t} )}{{\sum }_{{Z}_{t} = 1}^{N} P ( {x}_{t} \vert {Z}_{t} ) P ( {Z}_{t} )} \qquad ( 17 )$$

For P(Zₜ) of Formula (17), the following Formula (18) is employed so that only a transition having the highest probability among transitions to the state Zₜ is selected.

P(Zₜ)=max(P(Zₜ₋₁|X_{1:t-1})P(Zₜ|Zₜ₋₁))/Ω (18)

Ω in Formula (18) is a normalization constant of the probability of Formula (18). In addition, the probability distribution of an initial state is given with an equal probability to that of Formula (1) or an initial probability π(Z₁) is used when the initial probability π(Z₁) is known.

In the Viterbi algorithm, when only a transition having the highest probability among transitions to the state Zₜ from the step 1 to the step t in order is selected, it is necessary to store the transition that is selected. Thus, the data restoration unit 18 computes and stores a state Zₜ₋₁ of the transition having the highest probability among transitions to the step t by computing mₜ(Zₜ) expressed in the following Formula (19) in the step t. The data restoration unit 18 stores the state of the transition having the highest probability in each state from the step 1 to the step t by performing the same process as that of Formula (19).

mₜ(Zₜ)=argmax_{Z}_{ₜ₋₁}(P(Zₜ₋₁|x_{1:t-1})P(Zₜ|Zₜ₋₁)) (19)

Next, in Step S23, the data restoration unit 18 executes a backtrace process. The backtrace process is a process in which a state having the highest state probability (likelihood) is selected in the opposite direction of the time direction from the newest step t to the step 1 in time series data.

In Step S24, the data restoration unit 18 generates a maximum likelihood state series by arranging states obtained in the backtrace process in a time series manner.

In Step S25, the data restoration unit 18 restores measured data based on the state of the maximum likelihood state series corresponding to a missing data portion of the time series data. It is assumed that, for example, the missing data portion is a data piece of a step p from the step 1 to the step t. When the time series data has discrete symbols, restored data xₚ is generated using the following Formula (20).

xₚ=maxₓ_{ₚ}(P(xₚ|zₚ)) (20)

According to Formula (20), an observation xₚ having the highest likelihood is assigned as restored data in a state zₚ of the step p.

In addition, when the time series data has continuous symbols, a j-dimensional component xₚⱼ of the restored data xₚ is generated using the following Formula (21).

xₚⱼ=μ_{z}_{_{p,j}} (21)

In the process of Step S25, when the measured data is restored for all of the missing data portion of the time series data, the data restoration process ends.

As above, when time series data has missing data, the data restoration unit 18 estimates a maximum likelihood state series by applying the Viterbi algorithm, and restores measured data corresponding to the missing data portion of the time series data based on the estimated maximum likelihood state series.

Note that, in the present embodiment, data is generated (restored) only for a missing data portion of time series data based on the maximum likelihood state series, but data may be generated for entire time series data so as to be used in updating of a learning model.

The measurement control system 1 configured as above can be configured by an information processing device on which the main sensor 10 and the sub sensors 10 are mounted and a server that learns a learning model and supplies parameters of the learned learning model to the information processing device. In this case, the information processing device includes the sensor group 11, the timer 12, the sub sensor control unit 13, the measurement entropy calculation unit 14, the main sensor control unit 15, the main data estimation unit 16, and the data accumulation unit 17. In addition, the server includes the data restoration unit 18, and the model storage unit 19. Then, the information processing device periodically transmits time series data accumulated in the data storage unit 17 to the server one time a day, or the like, and the server updates a learning model when the time series data is added and supplies parameters after updating to the information processing device. The information processing device can be a mobile device, for example, a smartphone, a tablet terminal, or the like. When the information processing device has processing capability of learning a learning model based on accumulated time series data, the device may of course have the entire configuration of the measurement control system 1.

### Configuration Example of a Computer

The series of processes described above can be executed by hardware, or by software. When the series of processes are executed by software, a program constituting the software is installed in a computer. Herein, in such a computer, a computer incorporated into dedicated hardware, a general-purpose personal computer that can execute various functions by installing various programs therein, and the like are included.

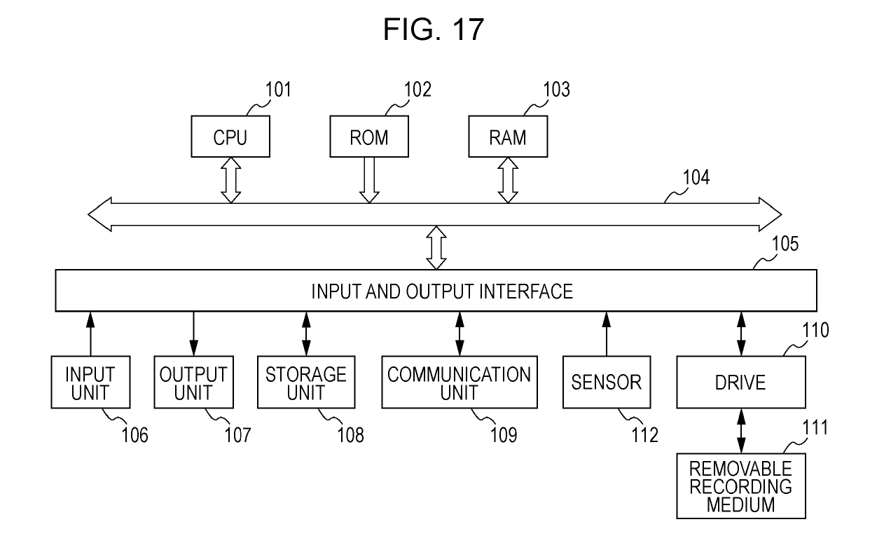

FIG. 17 is a block diagram showing a configuration example of hardware of a computer in which the series of processes described above are executed using a program.

In the computer, a Central Processing Unit (CPU) 101, a Read Only Memory (ROM) 102, and a Random Access Memory (RAM) 103 are connected to one another via a bus 104.

To the bus 104, an input and output interface 105 is connected. To the input and output interface 105, an input unit 106, an output unit 107, a storage unit 108, a communication unit 109, and a drive 110 are connected.

The input unit 106 includes a keyboard, a mouse, a microphone, or the like. The output unit 107 includes a display, a speaker, or the like. The storage unit 108 includes a hard disk, a non-volatile memory, or the like. The communication unit 109 includes a communication module that performs communication with other communication devices or base stations via the Internet, a mobile telephone network, a wireless LAN, a satellite broadcasting network, or the like. A sensor 112 is a sensor corresponding to the sensors 10 of FIG. 1. The drive 110 drives a removable recording medium 111 such as magnetic disks, optical disks, magneto-optical discs, or a semiconductor memory.

The series of processes above-described are performed in the computer configured as above in such a way that the CPU 101 loads a program stored in, for example, the storage unit 108 into the RAM 103 via the input and output interface 105 and the bus 104 so that the program is executed.

In the computer, the program can be installed in the storage unit 108 via the input and output interface 105 by mounting the removable recording medium 111 on the drive 110. In addition, the program can be received by the communication unit 109 via a wired or a wireless transmission medium such as a local area network, the Internet, or digital satellite broadcasting so as to be installed in the storage unit 108. In addition, the program can be installed in advance in the ROM 102 or the storage unit 108.

Note that, in the present specification, the steps described in the flowcharts may be performed in a time series manner following the described order, in a parallel manner, or at necessary time points when there is a call-out, not necessarily performed in the time series manner.

Note that, in the present specification, a system refers to a whole system configured to include a plurality of devices.

An embodiment of the present technology is not limited to the above-described embodiments, and can be variously modified within the scope not departing from the gist of the present technology.

Note that the present technology can have the following configurations.

(1) An information processing device that includes a main sensor that is a sensor that is operated in at least two operation levels and acquires predetermined data, a sub sensor that is a sensor that acquires data different from that of the main sensor, and an information amount calculation unit that predicts the difference between an information amount when measurement is performed by the main sensor and an information amount when measurement is not performed by the main sensor from data obtained by the sub sensor and decides the operation level of the main sensor based on the prediction result.

(2) The information processing device described in (1) above, in which the sub sensor is a sensor that incurs lower measurement costs for acquiring data than the main sensor.

(3) The information processing device described in (2) above, in which the information amount calculation unit decides the operation level of the main sensor by comparing the difference of the information amounts when measurement is performed and not performed by the main sensor to a threshold value based on a current margin of an index used to decide the measurement costs.

(4) The information processing device described in any one of (1) to (3) above, in which the information amount calculation unit acquires parameters of a probability model learned by time series data obtained by the main sensor and the sub sensor in the past, and predicts the difference of the information amounts when measurement is performed and not performed by the main sensor as the difference of information entropies of a probability distribution of the probability model when measurement is performed and not performed by the main sensor.

(5) The information processing device described in (4) above, in which the parameters of the probability model are an observation probability and a transition probability of each state of a Hidden Markov Model.

(6) The information processing device described in (4) or (5) above, in which, the parameters of the probability model are parameters of the center and variance of an observation generated from each state of a Hidden Markov model and a transition probability.

(7) The information processing device described in (5) above, in which the information amount when measurement is not performed by the main sensor is an information entropy computed from a probability distribution in which a posterior probability of a state variable of the Hidden Markov Model obtained from time series data up to the previous measurement and a prior probability of a state variable at a current time obtained from a transition probability of the state variable of the Hidden Markov model are predicted.

(8) The information processing device described in any one of (6) or (7) above, in which the information amount when measurement is performed by the main sensor is an information entropy obtained by in such a way that data obtained from measurement is expressed by an observation variable, and an expectation value of an information amount that can be computed from a posterior probability of the state variable of the Hidden Markov Model under the condition in which the observation variable is obtained is computed for the observation variable.

(9) The information processing device described in (8) above, in which, as the difference of the information amount when measurement is performed by the main sensor and the information amount when measurement is not performed by the main sensor, a mutual information amount of the state variable indicating a state of the Hidden Markov Model and the observation variable is used.

(10) The information processing device described in any one of (5) to (8) above, in which the information amount calculation unit causes a continuous probability variable corresponding to measured data obtained when measurement is performed by the main sensor to be approximate to a discrete variable having the same symbol as the state variable of the Hidden Markov Model so as to predict the difference of information entropies.

(11) The information processing device described in (10) above, in which the information amount calculation unit includes a variable conversion table in which the observation probability that the approximate discrete variable is obtained is stored for the state variable.

(12) An information processing method of an information processing device that includes a main sensor that is a sensor that is operated in at least two operation levels and acquires predetermined data, and a sub sensor that is a sensor that acquires data different from that of the main sensor, the method including steps of predicting the difference between an information amount when measurement is performed by the main sensor and an information amount when measurement is not performed by the main sensor from data obtained by the sub sensor and deciding the operation level of the main sensor based on the prediction result.

(13) A program for causing a computer that processes data acquired by a main sensor and a sub sensor to execute processes of predicting the difference between an information amount when measurement is performed by the main sensor and an information amount when measurement is not performed by the main sensor from data obtained by the sub sensor and deciding an operation level of the main sensor based on the prediction result.

The present disclosure contains subject matter related to that disclosed in Japanese Priority Patent Application JP 2012-073506 filed in the Japan Patent Office on Mar. 28, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a main sensor that is a sensor that is operated in at least two operation levels and acquires predetermined data;
a sub sensor that is a sensor that acquires data different from that of the main sensor; and
an information amount calculation unit that predicts the difference between an information amount when measurement is performed by the main sensor and an information amount when measurement is not performed by the main sensor from data obtained by the sub sensor and decides the operation level of the main sensor based on the prediction result.

2. The information processing device according to claim 1, wherein the sub sensor is a sensor that incurs lower measurement costs for acquiring data than the main sensor.

3. The information processing device according to claim 2, wherein the information amount calculation unit decides the operation level of the main sensor by comparing the difference of the information amounts when measurement is performed and not performed by the main sensor to a threshold value based on a current margin of an index used to decide the measurement costs.

4. The information processing device according to claim 1, wherein the information amount calculation unit acquires parameters of a probability model learned by time series data obtained by the main sensor and the sub sensor in the past, and predicts the difference of the information amounts when measurement is performed and not performed by the main sensor as the difference of information entropies of a probability distribution of the probability model when measurement is performed and not performed by the main sensor.

5. The information processing device according to claim 4, wherein the parameters of the probability model are an observation probability and a transition probability of each state of a Hidden Markov Model.

6. The information processing device according to claim 4, wherein the parameters of the probability model are parameters of the center and variance of an observation generated from each state of a Hidden Markov model and a transition probability.

7. The information processing device according to claim 5, wherein the information amount when measurement is not performed by the main sensor is an information entropy computed from a probability distribution in which a posterior probability of a state variable of the Hidden Markov Model obtained from time series data up to the previous measurement and a prior probability of a state variable at a current time obtained from a transition probability of the state variable of the Hidden Markov model are predicted.

8. The information processing device according to claim 5, wherein the information amount when measurement is performed by the main sensor is an information entropy obtained by in such a way that data obtained from measurement is expressed by an observation variable, and an expectation value of an information amount that can be computed from a posterior probability of the state variable of the Hidden Markov Model under the condition in which the observation variable is obtained is computed for the observation variable.

9. The information processing device according to claim 8, wherein, as the difference of the information amount when measurement is performed by the main sensor and the information amount when measurement is not performed by the main sensor, a mutual information amount of the state variable indicating a state of the Hidden Markov Model and the observation variable is used.

10. The information processing device according to claim 5, wherein the information amount calculation unit causes a continuous probability variable corresponding to measured data obtained when measurement is performed by the main sensor to be approximate to a discrete variable having the same symbol as the state variable of the Hidden Markov Model so as to predict the difference of information entropies.

11. The information processing device according to claim 10, wherein the information amount calculation unit includes a variable conversion table in which the observation probability that the approximate discrete variable is obtained is stored for the state variable.

12. An information processing method of an information processing device that includes a main sensor that is a sensor that is operated in at least two operation levels and acquires predetermined data, and a sub sensor that is a sensor that acquires data different from that of the main sensor, the method comprising:
predicting the difference between an information amount when measurement is performed by the main sensor and an information amount when measurement is not performed by the main sensor from data obtained by the sub sensor and deciding the operation level of the main sensor based on the prediction result.

13. A program for causing a computer that processes data acquired by a main sensor and a sub sensor to execute:
predicting the difference between an information amount when measurement is performed by the main sensor and an information amount when measurement is not performed by the main sensor from data obtained by the sub sensor and deciding an operation level of the main sensor based on the prediction result.
